(19) United States
(12) Patent Application Publication
(10) Pub. No.: US 2025/0392651 A1
(43) Pub. Date: Dec. 25, 2025

(54) TRIGGERED BASESTATION-ASSISTED EVENT DETECTION AND RECORD KEEPING

(71) Applicant: HUAWEI TECHNOLOGIES CO., LTD., SHENZHEN (CN)

(72) Inventors: Hesham Gamal Aly Mohamed MOUSSA, Kanata (CA); Mostafa MEDRA, Kanata (CA)

(73) Assignee: HUAWEI TECHNOLOGIES CO., LTD., SHENZHEN (CN)

(21) Appl. No.: 18/748,647

(22) Filed: Jun. 20, 2024

(51) Int. Cl. H04L 67/54; H04L 67/50; H04W 52/02

(52) U.S. Cl. CPC H04L 67/54; H04L 67/535

(57) ABSTRACT

Methods and apparatus for near-presence event detection are provided. Events are detected by nearby network entities such as user equipment or internet-of-things devices and reported thereby to an access point of a wireless network as a trigger. The trigger initiates a tagging of activity logs recorded by the access point to indicate an association with the event. The activity logs record entries for connection activities between the access point and network entities connecting to its wireless network. In some embodiments, the entries include information on the time and location for a connection activity and an identifier for the connecting network entity. In some embodiments, the access point provides a report including the tagged entries of the activity log.

### CROSS-REFERENCE TO RELATED APPLICATIONS

This is the first application filed for the present application.

### FIELD OF THE INVENTION

The present application pertains to communications networks and in particular to methods and apparatus for event detection.

### BACKGROUND

Near-presence detection refers to technological detection of objects or people in proximity to a point of interest. Near presence detection may, for example, be used to track and trace infections spreading throughout a population. In this case, a mobile application could be used by an individual person to register contacts with other people of the population over time. If one person were to report having an infection, the application could then determine who has been in close proximity with the infected person to notify or warn them of their potential contact. Different technologies, such as Bluetooth, Wi-Fi, and cellular technologies, can provide near presence detection over different geographical areas.

Unlike near-presence detection, event detection refers to technological detection involving measurement or monitoring to identify particular occurrences, either manually or automatically. For example, event detection could be directed towards detecting a positive infection in response to a test. Event detection typically involves the use of a monitoring device that measures a certain parameter such as temperature. Detection could be done, for example, by an internet-of-things (IoT) device such as a motion sensor. Integrated sensing and communication (ISAC) could similarly be used towards even detection. In another example, event detection could be directed towards monitoring water levels for a flood event by a water sensor, which could report measurements to a scientist at a remote location.

Technologies designed for near-presence detection are typically not capable of event detection and technologies designed for event detection are likewise not capable of near-presence detection. Techniques for performing both near-presence detection and event detection usually involve additional tools or complicated analytical techniques. Furthermore, devices used towards near-presence detection can lack user identifiers, may only detect devices of the same capabilities, and can have limited coverage. Meanwhile, devices used towards event detection are typically subsidiary to systems, can be needed in large numbers, can also lack user identifiers, and can require extensive analysis to obtain useful information.

Therefore, there is a need for methods and apparatus for near-presence and event detection that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide methods and apparatus for near-presence event detection.

A first aspect of the present disclosure is to provide a method for near-presence event detection. The method may be performed by an access point of a wireless network and may comprise: recording one or more activity entries in an activity log, each activity entry being associated with one of one or more network entities connected to the wireless network and indicating a respective activity time; receiving, from one of the one or more network entities at a notification time, a trigger indicating an event; and tagging, after the trigger is received and in accordance with the notification time and the respective activity time of each activity entry, at least one activity entry of the activity log to indicate a respective association with the event.

In some implementations of the first aspect, the method may further comprise: receiving, from another one of the one or more network entities at another notification time, another trigger indicating the event; and tagging, when the another trigger is received and in accordance with the another notification time and the respective activity time of each activity entry, at least one activity entry of the activity log to indicate a respective another association with the event. In some implementations of the first aspect, the method may further comprise receiving, from another one of the one or more network entities at another notification time, another trigger indicating the event, and the at least one activity entry of the activity log may be tagged to indicate the respective association with the event when the another trigger is received and in accordance with the another notification time.

In some implementations of the first aspect, the one network entity of the one or more network entities may be an integrated sensing and communication (ISAC) component, the ISAC having a sensor configured to detect the event. In some embodiments, the wireless network may be a cellular network. In some of these embodiments, the access point may be a base station. In some embodiments, each network entity of the one or more network entities may be one of a user equipment, an ISAC component, or an internet-of-things device.

In some implementations of the first aspect, the method may further comprise directing, after the trigger is received, at least one network entity of the one or more network entities to collect respective data on the event. In some of these embodiments, the method may further comprise receiving, from the at least one network entity, the respective data. In some other embodiments, the method may comprise directing the at least one network entity to store the respective data. In some embodiments, the at least one activity entry of the activity log may be tagged to indicate the respective association with the event in accordance with the respective data received from the at least one network entity.

In some implementations of the first aspect, each network entity may have a respective network entity log associated thereto indicating one or more respective activity entries; and the method may further comprise directing, after the trigger is received, at least one network entity of the one or more network entities to tag at least one respective activity entry of the respective network entity log.

In some implementations of the first aspect, the method may further comprise sending, to a further access point, the trigger received from the one network entity. In some embodiments, the method may further comprise sending, to at least one network entity of the one or more network entities, a message to wake up, the at least one network entity being an idle network entity.

In some implementations of the first aspect, the method may further comprise providing an event report including the at least one activity entry of the activity log. In some embodiments, the method further comprises providing an event report identifying at least one network entity of the one or more entities, the at least one network entity corresponding to one of the at least one activity entries tagged in the activity log.

In some implementations of the first aspect, tagging, after the trigger is received and in accordance with the notification time and the respective activity time of each activity entry, the at least one activity entry of the activity log to indicate the respective association with the event may include: tagging a first set of activity entries of the activity log and a second set of activity entries of the activity log to indicate the respective association with the event, the respective activity time for each activity entry of the first set of activity entries preceding the notification time and the respective activity time for each activity entry of the second set of activity entries succeeding the notification time.

In some implementations of the first aspect, each activity entry may indicate an entity identifier corresponding to the associated network entity of the one or more network entities. In some of these embodiments, the trigger may indicate one or more target entity identifiers, and each entity identifier of the at least one activity entry of the activity log may further correspond to one of the one or more target entity identifiers. In some of these embodiments, the method may still further comprise providing an event report identifying at least one of: a first set of entity identifiers including each entity identifier of the at least one activity entry of the activity log; and a second set of entity identifiers including at least one of the one or more target entity identifiers and excluding each entity identifier of the at least one activity entry of the activity log. In some embodiments, the method may further comprise providing, when the at least one activity entry of the activity log is tagged, an event report identifying the entity identifier of the at least one activity entry.

In some implementations of the first aspect, the trigger may identify event information including an event type for the event, and the at least one activity entry of the activity log may be tagged in accordance with the event information. In some embodiments, the trigger may identify a geographical area, and the at least one activity entry of the activity log is tagged to indicate the respective association with the event in accordance with the geographical area.

A second aspect of the present disclosure is to provide a system for near-presence event detection. The system may comprise one or more network entities, with at least one of the one or more network entities configured to detect an event, and an access point. The access point may be configured to: record one or more activity entries in an activity log, each activity entry being associated with one of the one or more network entities and indicating a respective activity time; receive, from the at least one network entity at a respective notification time, a respective trigger indicating the event; and tag, when the respective trigger from the at least one network entity is received and in accordance with the respective notification time and in accordance with the respective activity time of each activity entry, at least one activity entry of the activity log to indicate a respective association with the event.

A third aspect of the present disclosure is to provide an electronic device comprising a processor coupled to a non-transitory processor-readable memory, the memory having stored thereon instructions to be executed by the processor to implement, at an access node of a wireless network, the method of the first aspect and any variations thereof.

Embodiments of the present disclosure may facilitate a combination of near-presence detection with event detection. Embodiments may be compatible with a variety of network devices and may enable identification of network users having an association with an event. Embodiments may avoid complex analysis and algorithms typically needed for detecting events or the presence of individuals.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1A shows an example implementation of near-presence event detection, according to embodiments of the present disclosure.

FIG. 1B shows an example implementation of tagging for near-presence event detection, according to embodiments of the present disclosure.

FIG. 2 shows a flowchart of a method for near-presence event detection, according to embodiments of the present disclosure.

FIG. 3 shows an example of a messaging procedure for near-presence event detection, according to an embodiment of the present disclosure.

FIG. 4 shows another example of a messaging procedure for near-presence event detection, according to an embodiment of the present disclosure.

FIG. 5 shows a schematic for an example of near-presence event detection with a plurality of user equipment, according to an embodiment of the present disclosure.

FIG. 6 shows a schematic for an example of near-presence event detection with an integrated sensing and communication component, according to an embodiment of the present disclosure.

FIG. 7 shows a schematic for an example of near-presence event detection with data collection, according to an embodiment of the present disclosure.

FIG. 8 shows a schematic for an example of near-presence event detection with trigger forwarding, according to an embodiment of the present disclosure.

FIG. 9 shows a schematic of an apparatus for near-presence event detection according to embodiments of the present disclosure.

FIG. 10 shows a schematic of an embodiment of an electronic device that may implement at least part of the methods and features of the present disclosure.

It will be noted that throughout the appended drawings, like features are identified by like reference numerals.

### DETAILED DESCRIPTION

Embodiments of the present disclosure are generally directed towards providing methods, systems, and apparatus for near-presence event detection. An event may be detected by network entities that are near the event and that belong to a wireless network. The event may then be reported to an access point of the wireless network. A report of an event may trigger the access point to tag entries in a log recorded by the access point with an association to the event. The log entries may record connection activities between the access point and network entities connecting to the access point. In some embodiments, the log entries tagged with the association to the event may be reported. In some embodiments, the reported event may trigger commands to network entities or another access point of the wireless network.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. As used herein, the term “about” should be read as including variation from the nominal value, for example, a +/−10% variation from the nominal value. It is to be understood that such a variation is always included in a given value provided herein, whether or not it is specifically referred to. The terms in each of the following sets may be considered interchangeable throughout the disclosure: “access point” and “base station”; and “user equipment” and “network entity”.

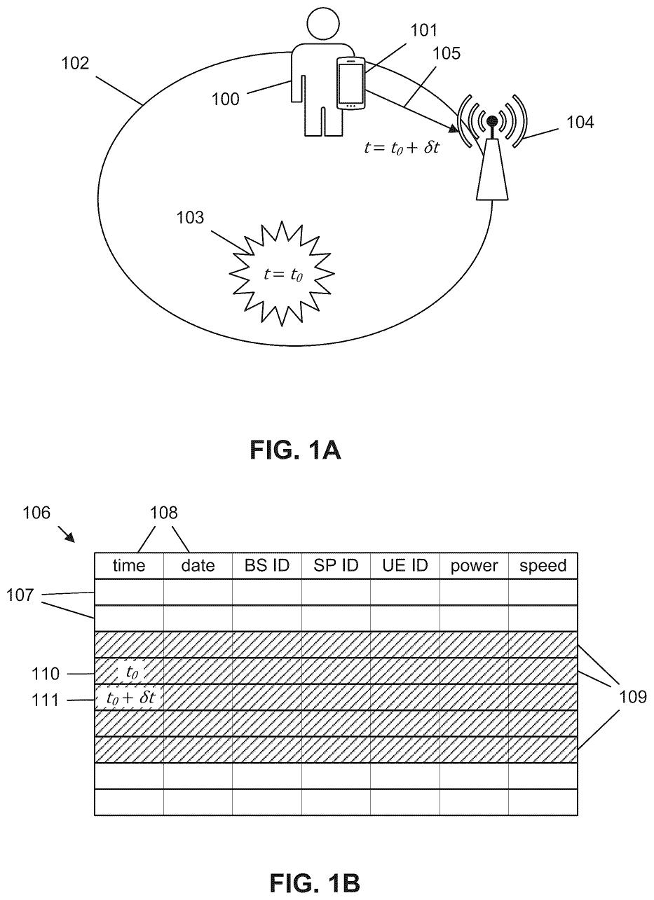

FIG. 1A shows an example implementation of an embodiment according to the present disclosure. Here, a user 100 with a user equipment 101 is in the vicinity 102 of an event 103 that occurs at time t=t₀. The event 103 may be any observable occurrence. For example, the event 103 may be a car accident observed by the user 100. The user equipment 101 may, for example, be a mobile phone that has an active connection to a wireless network through a nearby access point 104. The user equipment 101 may be considered as a network entity and, in some other embodiments, may, for example, be an internet-of-things (IoT) device or an integrated sensing and communication (ISAC) component. The access point 104 may, for example, be a base station of a cellular network, such as a 5G, or LTE network, and in some other embodiments, may be an access point of a Wi-Fi network or a satellite network, or network using other technologies. At time t=t₀+δₜ (referred to herein as the ‘notification time’), the user 100 may report the event 103 to the wireless network through their user equipment 101, or the user equipment 101 may be configured to automatically report event 103 to the wireless network. The user equipment 101 may send a trigger 105, or trigger signal, to the access point 104 to report the event 103. The notification time may, for example, be the time that the trigger 105 is sent or the time that it is received.

The access point 104 may record, for each connection activity between the access point 104 and any one network entity connecting to the access point 104, an activity entry in an activity log. Each connection activity may, for example, be a connection initialization or an active communication with the wireless network. Each activity entry may include a respective activity time for the connection activity. When the access point 104 receives the trigger 105 from the user equipment 101, it may tag at least one activity entry of the activity log in accordance with the notification time and the respective activity time of each activity entry. For example, the access point 104 may tag activity entries with activity times after t=t₀−Tₛ and until t=t₀+Tₑ, where Tₛ and Tₑ respectively define start and end times for a tagging period. In some other embodiments, activity entries with activity times after t=t₀+δt−Tₛ and until t=t₀+δt+Tₑ may be tagged by the access point 104. Tₛ and Tₑ may be pre-determined and adjustable, and may be set in accordance with a type for the event 103 or for the trigger 105.

FIG. 1B shows an example of an activity log 106 having activity entries 107 recorded by an access point 104. Each activity entry 107 includes one or more data fields 108 that may indicate information on the respective connection activity. Example of data fields 108 include a time and date of the connection activity, an identifier for the access point (BS ID), an identifier for the user equipment (UE ID), a transmission power, and a transmission speed. The activity log 106 further has tags 109 applied to some of the activity entries 107, indicating an association with the event 103. In FIG. 1B, the tags 109 have been applied to activity entries 107 preceding the event time 110, t₀, and exceeding the notification time 111, t₀+δt.

The implementation of FIGS. 1A and 1B may, for example, be applied to a car accident scenario, as noted above. In this scenario, the car accident may involve a driver of a car and the user 100 may be considered a witness to the car accident. The activity log 106 may be used by authorities such as a police service to identify the driver of the car that was involved in the car accident if that driver were to flee from the accident location. Alternatively or additionally, the activity log 106 may be used by authorities to identify the user 100 and additional witnesses who may have been in the vicinity 102 of the accident. In the example of FIG. 1A, the trigger 105 is sent manually by the user 100; in some other embodiments, the trigger 105 may be generated and sent to the access point 104 automatically. For example, the car accident may be detected by a traffic camera, the car of the car accident, or another car involved in the accident.

In some other implementations, embodiments of the present disclosure may be applied to monitor the presence of individuals within a certain geographical area, such as for monitoring attendance at schools or universities, or for billing riders of public transportation. For example, to monitor whether individuals remain within a prescribed area, a supervising user 100 may send a trigger 105 to the access point 104 wherein the trigger 105 indicates one or more identifiers for target network entities (i.e., targe entity identifiers) to be monitored, such as user equipment 101 belonging to the individuals. The trigger 105 may further indicate the prescribed area and/or a specified time period for monitoring. For example, the trigger may direct monitoring to be done on a specific day for a duration of a specific set of hours. Alternatively, the trigger 105 may have associated thereto a pre-determined prescribed area and/or a pre-determined time period. The event 103 may be an occurrence wherein the presence of individuals within a specified arca needs monitoring. For example, the event 103 may be an exam, a start of a school day, or a field trip, among other things that could prompt a need for a trigger 105. The access point 104 may, in the activity log 106, record an identifier of the network entity (i.e., an entity identifier) corresponding to each activity entry 107 and a geographical location for the connection activity. When the access point 104 receives the trigger 105, the access point 104 may tag activity entries 107 with entity identifiers corresponding to the target entity identifiers according to whether connection activities occur within the prescribed area. A report (i.e., an ‘event report’) may then be generated and sent to the supervising user 100 wherein the report identifies which of the target entity identifiers has been tagged or has not been tagged, for example, within the pre-determined or specified time period. For monitoring attendance at a school, the report may identify which students were present and/or absent in class; whereas, for monitoring public transit usage, the report may identify individuals who used a bus or train service and may compare this record against a billing record. The access point 104 may further generate an event report to alert the supervising user 100 if any connection activity of a target network entity occurs outside the prescribed area. The event report may be generated when an activity entry 107 is tagged and may indicate the target entity identifier corresponding to the activity entry 107. For example, when monitoring attendance of students on a field trip, an event report could be generated to notify a supervising user 100 that a specific student has disappeared from the prescribed area.

In some other implementations, embodiments of the present disclosure may be applied for automatic proximity detection. Here, a trigger may be automatically generated when one network entity comes into proximity within another network entity. For example, these embodiments may be applied to enforce restraining orders between individuals.

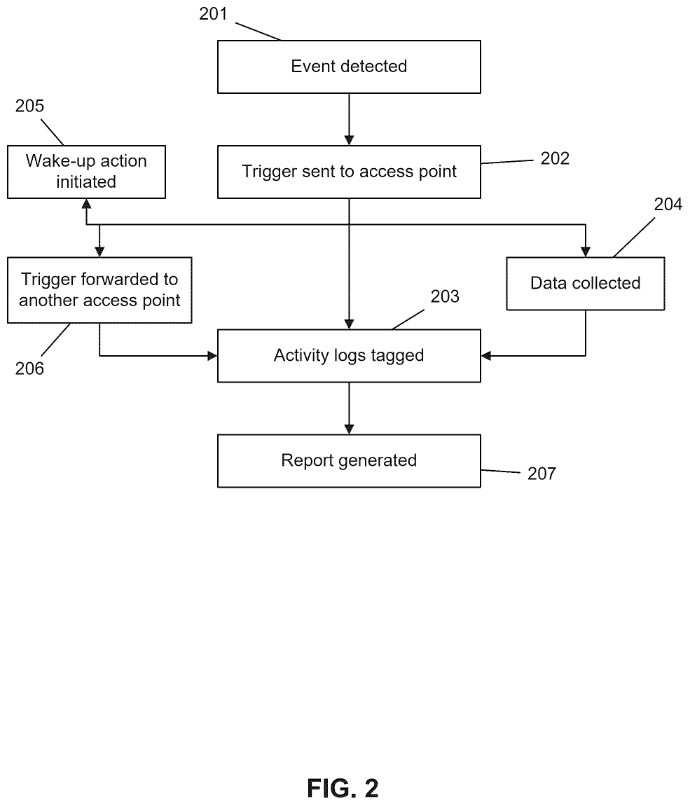

FIG. 2 shows a flowchart of a method for near-presence event detection in accordance with an embodiment of the present disclosure. At action 201, an event 103 may be detected, such as by a user 100, user equipment 101, IoT device, or ISAC component. At action 202, a trigger 105 may then be generated and sent, automatically or manually, to an access point 104. The trigger may indicate event information, such as an event type, one or more target entity identifiers, an event time, a notification time, and a geographical area or position. For example, the trigger may indicate the event as a car accident or a theft of property, and may further identify features related to parties involved in the event such as car or clothing colors. The access point 104 may, for example, be a base station of a cellular network or a Wi-Fi access point. The access point 104 may further record an activity log 106 with activity entries 107 for each connection activity. Each activity entry 107 may include an activity time for the respective connection activity. At action 203, the access point 104 may tag at least one activity entry 107 of the activity log 106 to indicate an association with the event 103. Tagging may be done in accordance with the trigger 105, and in particular, in accordance with the notification time of the trigger 105 and the activity time of each activity entry. The trigger 105 may initiate optional actions prior to or in parallel to action 203. These actions may include, for example: collecting data, at action 204; initiating, at action 205, a wake-up action by a network entity connected to the access point 104; and forwarding of the trigger 105 to a further access point 104, at action 206. Data collected at action 204 may be used towards the tagging performed at action 203. In response to receiving the forwarded trigger 105 at action 206, the further access point 104 may in turn proceed to action 203 and/or any optional actions. At action 207, a report (i.e., an ‘event report’) may be generated providing, for example, tagged activity entries and/or identifiers for network entities.

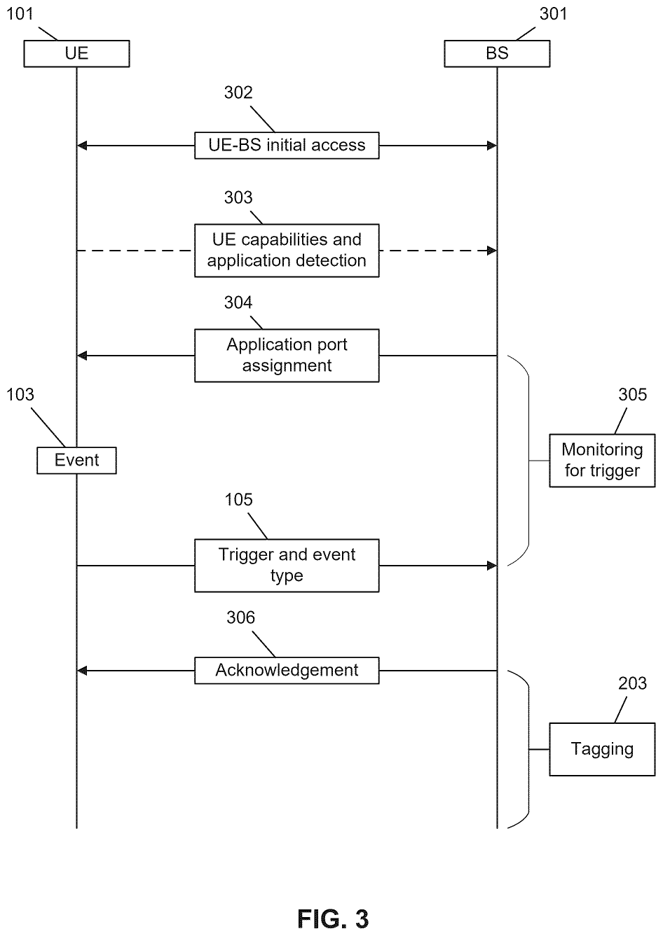

FIG. 3 shows an example of a messaging procedure for near-presence event detection in accordance with an embodiment of the present disclosure. First, a user equipment (UE) 101 and a base station (BS) 301 of a wireless network may establish a wireless connection providing initial access 302 of the UE 101 to the wireless network. The UE 101 may provide to the BS 301 information 303 on the capabilities of the UE 101, and the BS 301 may detect applications operated by the UE 101. The BS 301 may subsequently provide an assignment 304 of application ports to the UE 101. The BS 301 may monitor 305 wireless communications for a trigger related to an event 103. The UE 101 may detect, either manually by input from a user 100 or automatically by a sensor, an event 103 and send to the BS 301 a trigger 105 indicating an event type for the event 103. The BS 301 may send to the UE 101 an acknowledgement 306 of the trigger 105. If the acknowledgment 306 is not received by the UE 101, the UE 101 may resend the trigger 105. The BS may further tag at least one activity entry 107 of an activity log 106 recorded by the BS 301. Recording of activity entries 107 in the activity log 106 may have been on-going or may be initiated upon receipt of the trigger 105. Tagging may be done in accordance with the event type and a notification time associated with the trigger 105. The messaging procedure of FIG. 3 may, for example, be implemented for the detection and reporting of car accidents, as described hereinabove.

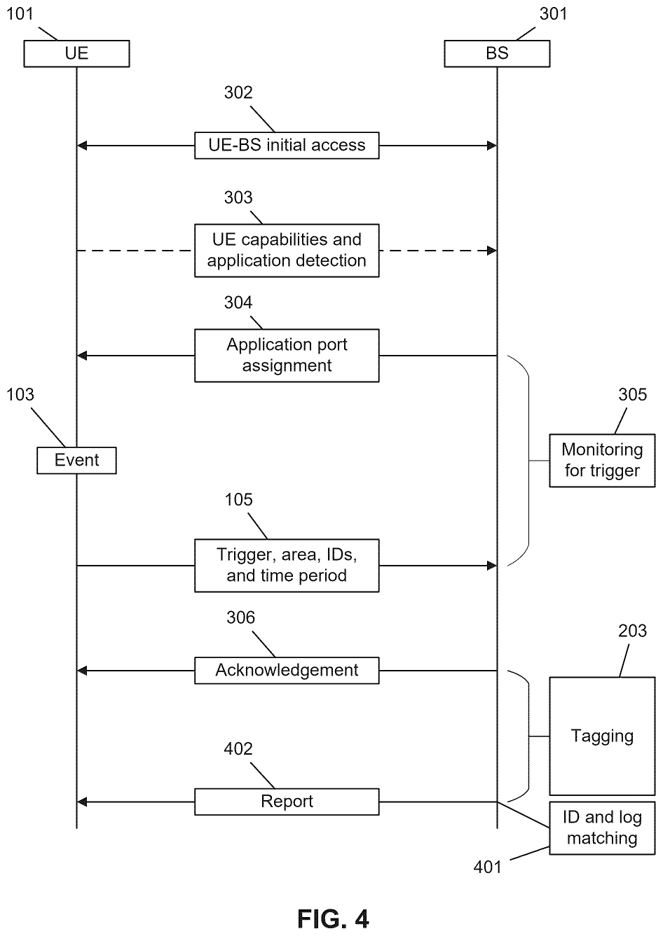

FIG. 4 shows another example of a messaging procedure for near-presence event detection in accordance with an embodiment of the present disclosure. The messaging procedure of FIG. 4 is similar to that shown in FIG. 3; however, in the messaging procedure of FIG. 4, the trigger 105 may include a geographical area, target entity identifiers, and a time period. After the trigger 105 is received by the BS 301, the BS 301 may tag activity entries 107 corresponding to the geographical area, target entity identifiers, and time period of the trigger 105. The BS 301 may further establish a record of which target entity identifiers have corresponded to activity entries 107 in the activity log 106 by matching 401 activity entries 107 to target entity identifiers. The BS 301 may generate a report 402 in accordance with this record and send the report 402 to the UE 101. The messaging procedure of FIG. 4 may, for example, be implemented for monitoring the presence of individuals within the specified geographical area, such as for monitoring attendance in schools, as described hereinabove.

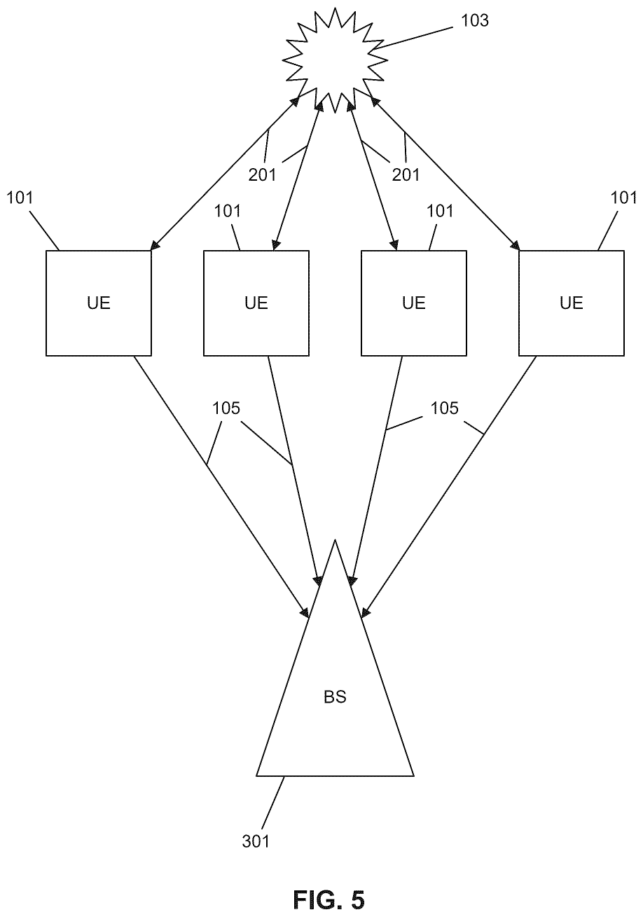

FIG. 5 shows a schematic for an example of near-presence event detection in accordance with an embodiment of the present disclosure. Here, a plurality of UEs 101 each detect a same event 103 and send a respective trigger 105 to a BS 301 to report the same event 103. Each trigger 105 may have associated with it a respective notification time. The BS 301 may implement any of actions 203 to 207, as described in relation to FIG. 2, separately or collectively for the triggers 105 received from the plurality of UEs 101. For example, the BS 301 may tag 203 activity entries 107 of an activity log 106 in accordance with the trigger 105 of one UE 101 of the plurality of UEs 101 and without consideration of the triggers from other UEs 101 of the plurality of UEs 101. Alternatively, the BS 301 may tag 203 the activity entries 107 in accordance with all the triggers 105 received. In other words, the activity entries 107 may be tagged with either multiple sets of tags 109 for the same event 103 or a single set of tags 109 for the same event 103.

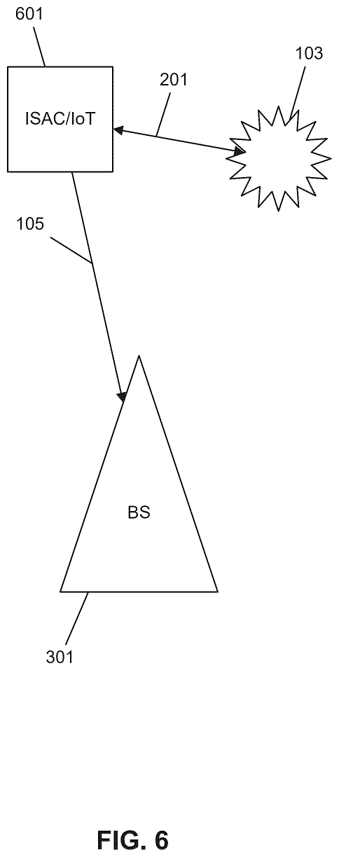

FIG. 6 shows a schematic for another example of near-presence event detection in accordance with an embodiment of the present disclosure. Here, either an ISAC component 601 or IoT device 601 detects 201 an event 103, such as through a sensor element. For example, an IoT device 601 may have a camera to detect a car accident or may have a water level sensor to detect a flood. When the event 103 is detected, the ISAC component 601 or IoT device 601 may automatically send a trigger 105 to a BS 301 to report the event 103. The BS 301 may then implement any of actions of 203 to 207, as described in relation to FIG. 2, which may include tagging 203 activity entries 107 of an activity log 106 in accordance with the trigger 105.

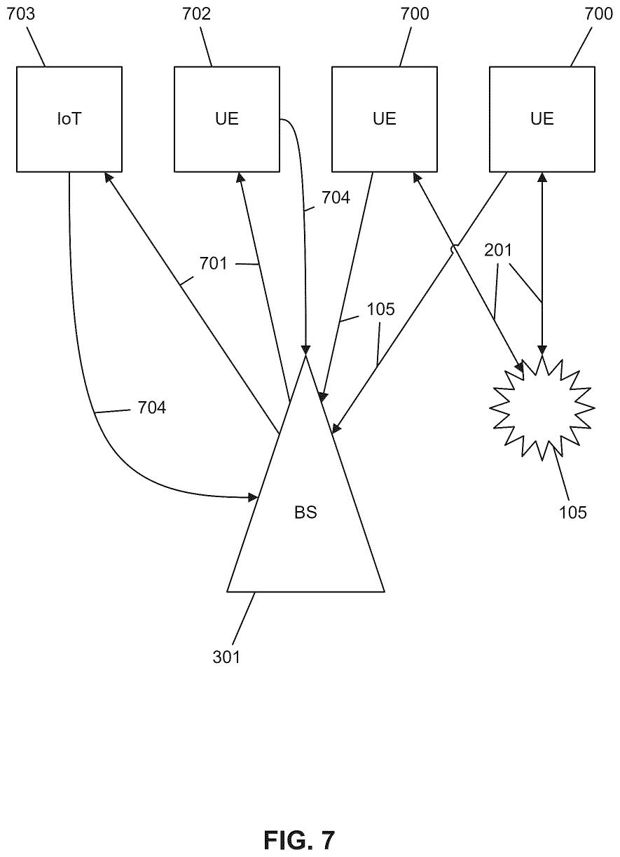

FIG. 7 shows a schematic for another example of near-presence event detection in accordance with an embodiment of the present disclosure. Here, a first one or more UEs 700 each detect 201 a same event 105 and send a respective trigger 105 to a BS 301 to report the same event 103. In response to receiving each trigger 105, the BS 301 may direct 701 a second one or more UEs 702 and/or one or more other network entities 703, such as an IoT device, to collect data. Data may be collected, for example, on the same event 105, the environment of each network entity, and/or the status of each network entity. Each of the second one or more UEs 702 and each of the one or more other network entities 703 may send 704 the collected data, or a data report depending therefrom, to the BS 301. A data report may, for example, be an analysis of data collected by the respective network entity. The BS 301 may tag 203 activity entries 107 of an activity log 106 in accordance with the trigger 105 and the data and/or data reports received. The BS 301 may further record an additional log identifying the second one or more UEs 702 and one or more other network entities 703 that were instructed to collect data. In some implementations, the BS 301 may direct each of the second one or more UEs 702 and one or more other network entities 703 to store the respective data. Data that is stored may have associated with it an identifier indicating a relation to the same event 103 so that the stored data can be accessed at a later time.

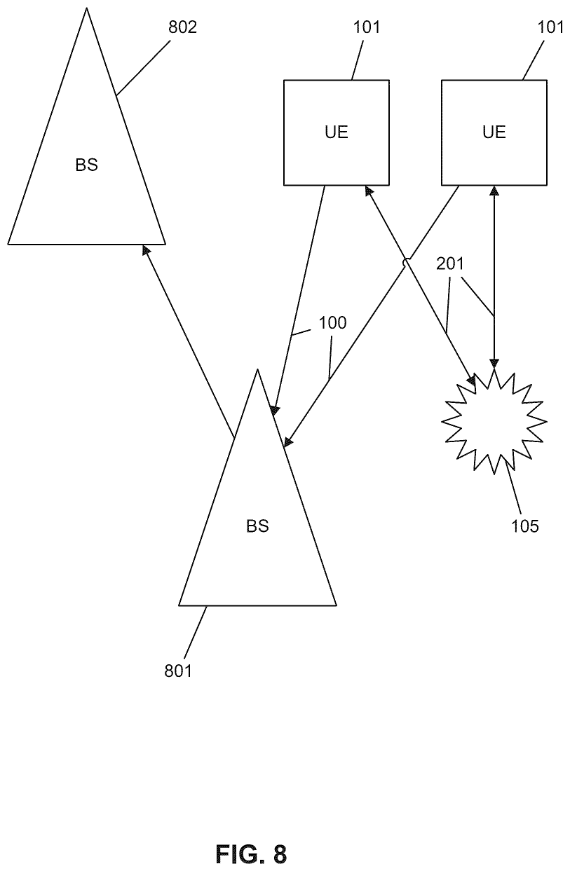

FIG. 8 shows a schematic for another example of near-presence event detection in accordance with an embodiment of the present disclosure. Here, one or more UEs 101 each detect 201 a same event 105 and send a respective trigger 105 to a primary BS 801 to report the same event 105. When each trigger 105 is received by the primary BS 801, the primary BS 801 may send, or forward, the respective trigger 105 to one or more secondary BSs 802. Each of the one or more secondary BSs 802 may, in turn, forward the respective trigger 105 to one or more tertiary BSs. In other words, each BS 302 receiving a trigger 105 may forward the trigger 105 to another BS 302. Each BS 302 receiving a trigger 105 may further tag 203 activity entries 107 of a respective activity log 106 in accordance with the trigger 105. In some implementations, each secondary BS 802, or any successive BS 302, may send its respective activity log 106 to the primary BS 801. The primary BS 801 may record an additional log identifying the secondary BSs 802. In some other embodiments, each network entity may have associated with it a respective network entity log indicating one or more respective activity entries. In these embodiments, the primary BS 801 may direct at least one network entity to tag at least one respective activity entry of the respective network entity log.

Embodiments of the present disclosure may be implemented using electronics hardware, software, or a combination thereof. In some embodiments, the invention may be implemented by one or multiple computer processors executing program instructions stored in memory. In some embodiments, the invention may be implemented partially or fully in hardware, for example using one or more field programmable gate arrays (FPGAs) or application specific integrated circuits (ASICs) to rapidly perform processing operations.

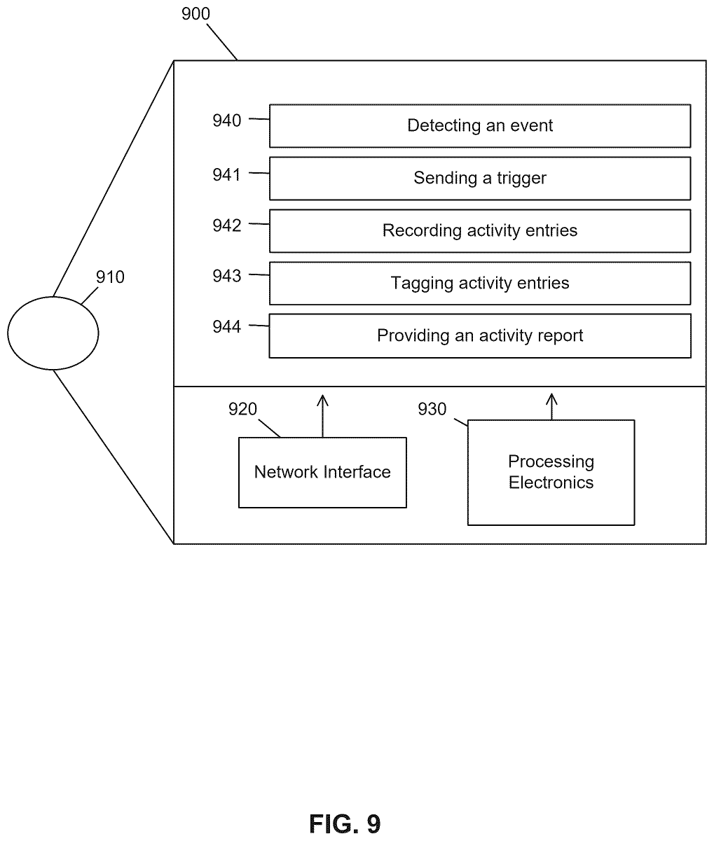

FIG. 9 shows an apparatus 900 for near-presence event detection, according to embodiments of the present disclosure. The apparatus may be located at a node 910 of a wireless network, such as at a user equipment 101 or a base station 301. The apparatus 900 may include a network interface 920 and processing electronics 930. The processing electronics 930 may include a computer processor executing program instructions stored in memory, or other electronics components such as digital circuitry, including for example FPGAs and ASICs. The network interface 920 may include an optical communication interface or radio communication interface, such as a transmitter and receiver. The apparatus 900 may include several functional components, each of which may be partially or fully implemented using the underlying network interface 920 and processing electronics 930. Examples of functional components may include modules for detecting 940 an event, sending 941 a trigger, recording 942 activity entries, tagging 943 activity entries, and providing 944 an activity report.

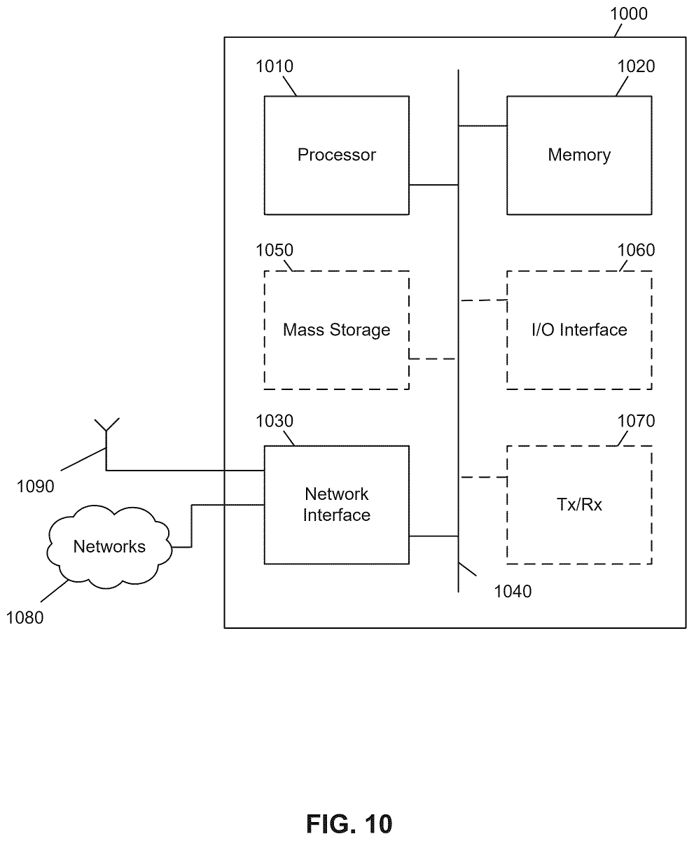

FIG. 10 shows a schematic diagram of an electronic device 1000 that may perform any or all of the operations of the above methods and features explicitly or implicitly described herein, according to different embodiments of the present disclosure. For example, a computer equipped with network function may be configured as electronic device 1000. The electronic device 1000 may be used to implement the apparatus 900 of FIG. 9, for example. The electronic device 1000 may further be used as part of a user equipment 101 or a base station 301, for example.

As shown, the electronic device 1000 may include a processor 1010, such as a Central Processing Unit (CPU) or specialized processors such as a Graphics Processing Unit (GPU) or other such processor unit, memory 1020, network interface 1030, and a bi-directional bus 1040 to communicatively couple the components of electronic device 1000. Electronic device 1000 may also optionally include non-transitory mass storage 1050, an I/O interface 1060, and a transceiver 1070. According to certain embodiments, any or all of the depicted elements may be utilized, or only a subset of the elements. Further, the electronic device 1000 may contain multiple instances of certain elements, such as multiple processors, memories, or transceivers. Also, elements of the hardware device may be directly coupled to other elements without the bi-directional bus 1040. Additionally or alternatively to a processor and memory, other electronics, such as integrated circuits, may be employed for performing the required logical operations.

The memory 1020 may include any type of tangible, non-transitory memory such as static random access memory (SRAM), dynamic random access memory (DRAM), synchronous DRAM (SDRAM), read-only memory (ROM), any combination of such, or the like. The mass storage element 1050 may include any type of tangible, non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1050 may have recorded thereon statements and instructions executable by the processor 1010 for performing any of the aforementioned method operations described above.

Network interface 1030 may include at least one of a wired network interface and a wireless network interface. The network interface 1030 may include a wired network interface to connect to a communication network 1080 and may also include a radio access network interface 1090 for connecting to the communication network 1080 or other network elements over a radio link. The network interface 1030 enables the electronic device 1000 to communicate with remote entities such as those connected to the communication network 1080.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product may include a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise. The phrase “at least one” means one or more, and “a plurality of” means two or more. In addition, “and/or” describes an association relationship of associated objects, and indicates that there may be three relationships. For example, A and/or B may indicate cases including “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent “a”, “b”, “c”, “a and b”, “a and c”, “b and c”, or “a, b and c”, where a, b, and c may be a single or multiple form.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via an electronic element depending on the particular context. The term “and/or” herein when used in association with a list of items means any one or more of the items comprising that list.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising, by an access point of a wireless network:
recording one or more activity entries in an activity log, each activity entry being associated with one of one or more network entities connected to the wireless network and indicating a respective activity time;
receiving, from one network entity of the one or more network entities at a notification time, a trigger indicating an event; and
tagging, in accordance with the notification time and the respective activity time of each activity entry, at least one activity entry of the one or more activity entries to indicate a respective association with the event.

2. The method of claim 1 further comprising, by the access point:
receiving, from another one of the one or more network entities at another notification time, another trigger indicating the event; and
tagging, in accordance with the another notification time and the respective activity time of each activity entry, at least one activity entry of the one or more activity entries log to indicate a respective another association with the event.

3. The method of claim 1 wherein:
the method further comprises, by the access point:
receiving, from another one of the one or more network entities at another notification time, another trigger indicating the event;
and the at least one activity entry is tagged to indicate the respective association with the event when the another trigger is received and in accordance with the another notification time.

4. The method of claim 1 further comprising, by the access point:
directing at least one network entity of the one or more network entities to collect respective data on the event.

5. The method of claim 4 further comprising, by the access point:
receiving, from the at least one network entity, the respective data.

6. The method of claim 4 further comprising, by the access point:
directing the at least one network entity to store the respective data.

7. The method of claim 5 wherein the at least one activity entry of the one or more activity entries is tagged to indicate the respective association with the event in accordance with the respective data received from the at least one network entity.

8. The method of claim 1 wherein:
each network entity has a respective network entity log associated thereto indicating one or more respective activity entries; and
the method further comprises, by the access point:
directing, at least one network entity of the one or more network entities to tag at least one respective activity entry of the respective network entity log.

9. The method of claim 1 further comprising, by the access point:
sending, to a further access point, the trigger received from the one network entity.

10. The method of claim 1 further comprising, by the access point:
sending, to at least one network entity of the one or more network entities, a message to wake up, the at least one network entity being an idle network entity.

11. The method of claim 1 further comprising, by the access point:
providing an event report including the at least one activity entry.

12. The method of claim 1 further comprising, by the access point:
providing an event report identifying at least one network entity of the one or more entities, the at least one network entity corresponding to one of the at least one activity entry tagged in the activity log.

13. The method of claim 1 wherein tagging, in accordance with the notification time and the respective activity time of each activity entry, the at least one activity entry of the one or more activity entries to indicate the respective association with the event includes:
tagging a first set of activity entries of the one or more activity entries and a second set of activity entries of the one or more activity entries to indicate the respective association with the event, the respective activity time for each activity entry of the first set of activity entries preceding the notification time and the respective activity time for each activity entry of the second set of activity entries succeeding the notification time.

14. The method of claim 1 wherein:
each activity entry indicates an entity identifier corresponding to the associated network entity of the one or more network entities;
the trigger indicates one or more target entity identifiers; and
each entity identifier of the at least one activity entry further corresponds to one of the one or more target entity identifiers.

15. The method of claim 14 further comprising, by the access point:
providing an event report identifying at least one of:
a first set of entity identifiers including each entity identifier of the at least one activity entry; and
a second set of entity identifiers including at least one of the one or more target entity identifiers and excluding each entity identifier of the at least one activity entry.

16. The method of claim 14 further comprising, by the access point:
providing an event report identifying the entity identifier of the at least one activity entry.

17. The method of claim 1 wherein the trigger further indicates event information including an event type for the event, and the at least one activity entry is tagged in accordance with the event information.

18. The method of claim 1 wherein:
the trigger identifies a geographical area; and
the at least one activity entry is tagged to indicate the respective association with the event in accordance with the geographical area.

19. A system comprising:
one or more network entities, at least one network entity of the one or more network entities configured to detect an event; and
an access point configured to:
record one or more activity entries in an activity log, each activity entry being associated with one of the one or more network entities and indicating a respective activity time;
receive, from the at least one network entity at a respective notification time, a respective trigger indicating the event; and
tag in accordance with the respective notification time and in accordance with the respective activity time of each activity entry, at least one activity entry of the one or more activity entries to indicate a respective association with the event.

20. An electronic device comprising a processor coupled to a non-transitory processor-readable memory, the memory having stored thereon instructions to be executed by the processor to implement a method comprising, at an access node of a wireless network:
recording one or more activity entries in an activity log, each activity entry being associated with one of one or more network entities connected to the wireless network and indicating a respective activity time;
receiving, from one network entity of the one or more network entities at a notification time, a trigger indicating an event; and
tagging and the respective activity time of each activity entry, at least one activity entry of the one or more activity entries to indicate a respective association with the event.
